(19) United States
(12) Patent Application Publication
(10) Pub. No.: US 2007/0159495 A1
(43) Pub. Date: Jul. 12, 2007

(54) Method and system for processing an image

(75) Inventors: Yu-Min Chang, Taipei (TW); Hsiang-Chun Lin, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASMedia Technology, Inc.

(21) Appl. No.: 11/438,615

(22) Filed: May 22, 2006

(30) Foreign Application Priority Data
Jan. 6, 2006 (TW) 95100635

(51) Int. Cl. G09G 5/00

(52) U.S. Cl. 345/617

(57) ABSTRACT

A method and system for processing an image is provided. The method and system are used to enhance the sharpness of the image. First, an input pixel value is filtered for producing a filter value. Afterwards, an output pixel value is determined according to whether the compensation value is higher than the threshold value. If the compensation value is higher than the threshold value, the output pixel value is the input pixel value merged with the threshold value. If the compensation value is not higher than the threshold, the output pixel value is the input pixel value merged with the compensation value.

### RELATED APPLICATIONS

The present application is based on, and claims priority from, Taiwan Application Serial Number 95100635, filed Jan. 6, 2006, the disclosure of which is hereby incorporated by reference herein in its entirety.

### BACKGROUND OF THE INVENTION

1. Field of Invention

The invention relates to a method and system for processing an image and, in particular, to a method and system for processing the sharpness and noises of an image.

2. Related Art

With advances in the design and manufacturing techniques of electronic devices, users have higher demands in the functions and quality of products. For image display devices for showing video images, it is an important issue to provide users with clearer and more vivid image quality. Therefore, modem image display devices are usually equipped with a processing module for beautifying and providing the best final images. Enhancing the sharpness of images is one of the main image processing operations.

The purpose of enhancing the sharpness is to separate an object from its background in a video image, thereby highlighting the object. FIG. 1A shows an image 100a containing a background image 102 and an object image 104. The colors of the object image 104 are darker than those of the background (here we assume that the darker colors have higher pixel values in the image display device). An edge 106 is formed at the interface between the background image 102 and the object image 104. From the variation of the pixel values, it is seen that a high-frequency region 108 appears at the edge 106.

Currently, a usual method for enhancing the sharpness of images is achieved by enhancing the edge colors of the object image 104. An image 100b obtained by enhancing the image 100a in FIG. 1A using the usual method is shown in FIG. 1B. It is seen in the image 100b that a dark-color enhancing region 112 is generated between the object image 104 and the edge 106. The dark-color enhancing region 112 is obtained by enhancing part of the object image 104 that is closer to the edge 106. It has the effect of enhancing the sharpness of the object image 104. From the viewpoint of pixel values, their variation in the dark-color enhancing region 112 is seen in the high-frequency region 114b between the object image 104 and the edge 106.

On the other hand, this method also has an enhancement on the side of the background image 102. However, if the colors of the background image 102 are lighter, a totally different effect may be produced. As shown in image 100b, a light-color enhancing region 110 is further generated between the background image 102 and the edge 106. The light-color enhancing region 110 is obtained by enhancing the part of the background image 102 that is closer to the edge 106. Since light colors become lighter after the enhancement, an unexpected white edge is then formed between the background image 102 and the edge 106. From the viewpoint of pixel values, their variation in the light-color enhancing region 110 is seen in the high-frequency region 114a between the background image 102 and the edge 106. When the appearance of this white edge affects seriously the visual effect of the image 100b, we call this overshooting.

From the above discussions we know that sharpness enhancement and overshooting of an image are often closely related. It is thus imperative to provide a method for enhancing image sharpness while balancing between these two effects at the same time, so that one can obtain images whose sharpness is appropriately enhanced without overshooting.

### SUMMARY OF THE INVENTION

An objective of the invention is to provide a method and system for reducing the overshooting phenomena.

Another objective of the invention is to provide a method and system for enhancing the visual quality of images.

A further objective of the invention is to provide a method and system for flexibly adjusting the image quality.

To achieve the above objectives, the image sharpness enhancing method in accord with an embodiment of the invention takes out each pixel in an image and performs operations on the pixel value. First, an input pixel value is filtered for producing a filter value. Afterwards, an output pixel value is determined according to whether the compensation value is higher than the threshold value. If the compensation value is higher than the threshold value, the output pixel value is the input pixel value merged with the threshold value. If the compensation value is not higher than the threshold, the output pixel value is the input pixel value merged with the compensation value.

The above-mentioned method for enhancing the sharpness of images can be implemented in a system for enhancing the sharpness of images using a circuit or a program. The system includes a high-frequency filtering module, an adjusting module, and a merging module. The high-frequency filtering module is used to filter an input pixel value and output a filter value. The magnitude of the filter value determines whether the input pixel value is in a high-frequency region. The adjusting module determines whether the magnitude of the compensation value is higher than a threshold value. If the compensation value is higher than the threshold value, the output pixel value is the input pixel value merged with the threshold value. If the compensation value is not higher than the threshold, the output pixel value is the input pixel value merged with the compensation value. Moreover, the disclosed system may further include a gain module for enhancing the filter value for the convenience of subsequent processing.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1A is a schematic view of an image; FIG. 1B is a schematic view of an image processed using a conventional image sharpness enhancement method;

FIG. 2 is a flowchart of the method for enhancing image sharpness according to an embodiment of the invention;

FIG. 3A shows the structure of the disclosed system for enhancing image sharpness according to one embodiment of the invention;

FIG. 3B shows the structure of the disclosed system for enhancing image sharpness according to another embodiment of the invention;

FIG. 4 is a schematic view of a mask matrix used in the high-frequency filtering module in an embodiment of the invention; and

FIG. 5 is a schematic view of a calculating matrix used in the high-frequency filtering module in an embodiment of the invention.

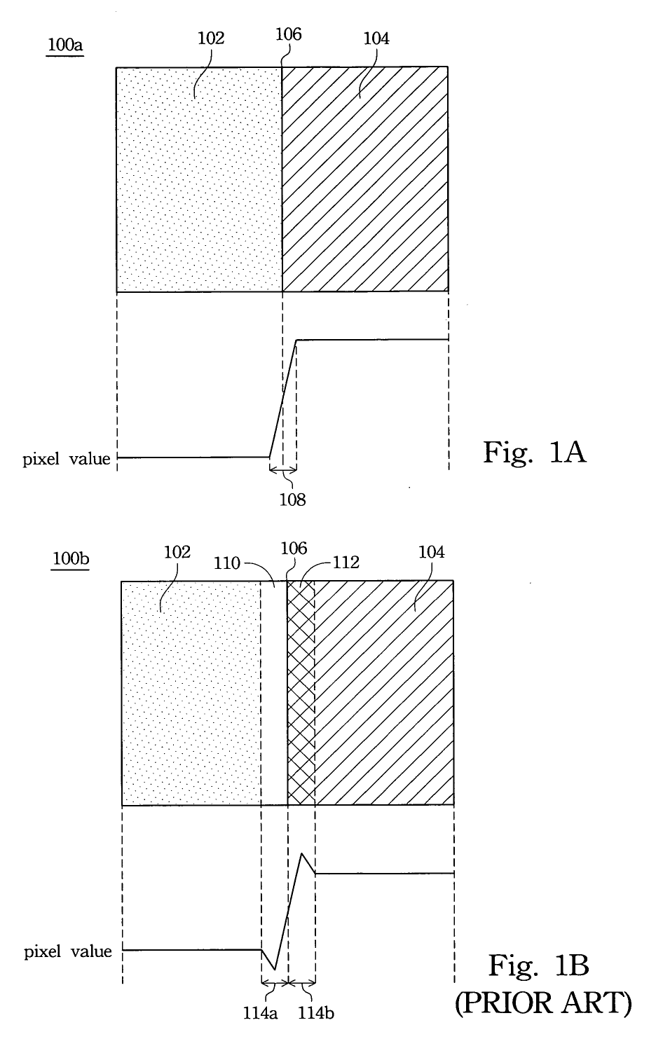

### DETAILED DESCRIPTION OF THE INVENTION

The present invention will be apparent from the following detailed description, which proceeds with reference to the accompanying drawings, wherein the same references relate to the same elements.

Each image displayed by an image display device consists of many pixels. Each pixel corresponds to one pixel value that represents the color thereof. The disclosed embodiment performs operations on these pixel values to obtain better output pixel values for promoting the image quality as well as reducing the overshooting phenomenon.

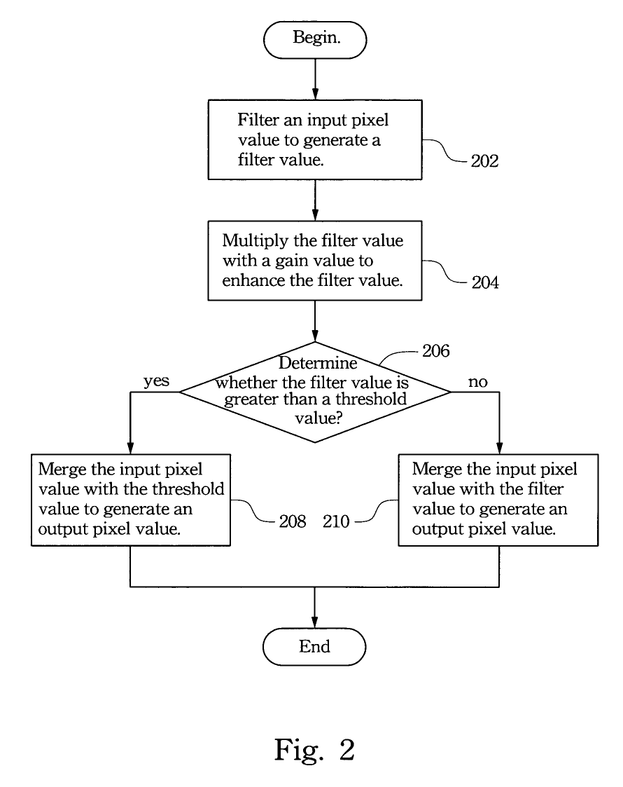

FIG. 2 is a flowchart of the disclosed image processing method that processes the image sharpness. In step 202, an input pixel value is filtered to generate a filter value. The magnitude of the filter value is used to determine whether the pixel represented by the input pixel value is in a high-frequency region in the image. In step 204, the filter value produced in step 202 is multiplied by a gain value to increase the intensity of the filter value. The gain value may be 1. That is, the intensity of the filter value is determined according to needs in this method. Step 206 determines whether the filter values generated in step 202 or 204 is too large. A large filter value may result in overshooting. In particular, the compensation value is compared with a predetermined threshold value whose magnitude is preset and adjusted according to the usage and design. If the determination result is “yes” in step 206, it means the compensation value is too large and step 208 follows. In this case, the input pixel value is merged with the threshold value to determine the output pixel value. If the determination result is “no” in step 206, it means the compensation value is appropriate and step 210 follows. In this case, the output pixel value is the input pixel value merged with the filter value. After calculation all the pixels in the pixels, the output pixel values form an image with better sharpness but no overshooting.

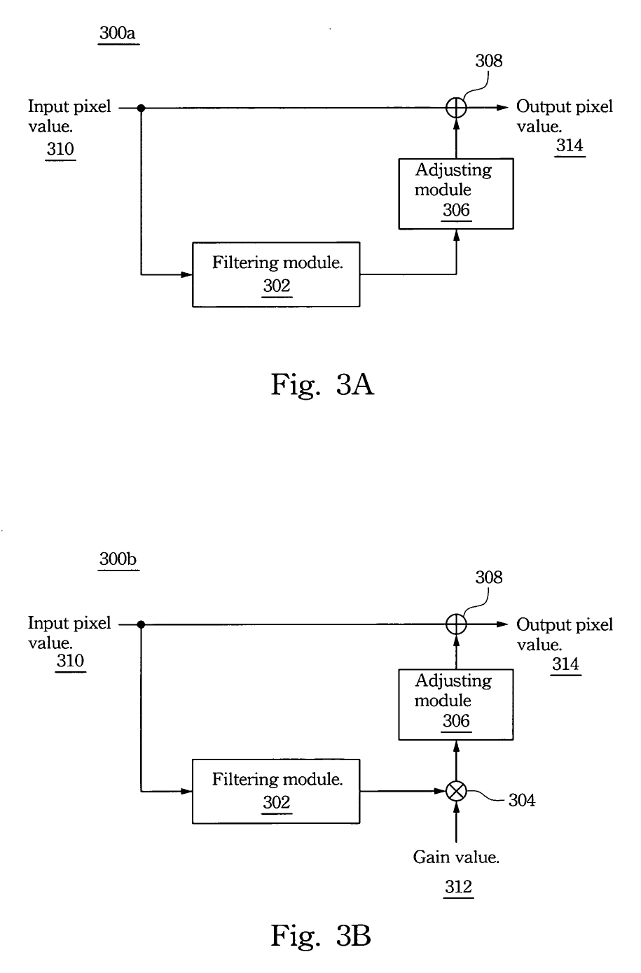

In accord with the above-mentioned method, a system for enhancing image sharpness can be implemented using a software program or hardware circuit. FIG. 3A shows the image sharpness processing system 300a according to another embodiment of the invention. It includes a filtering module 302, an adjusting module 306, and a merging module 308.

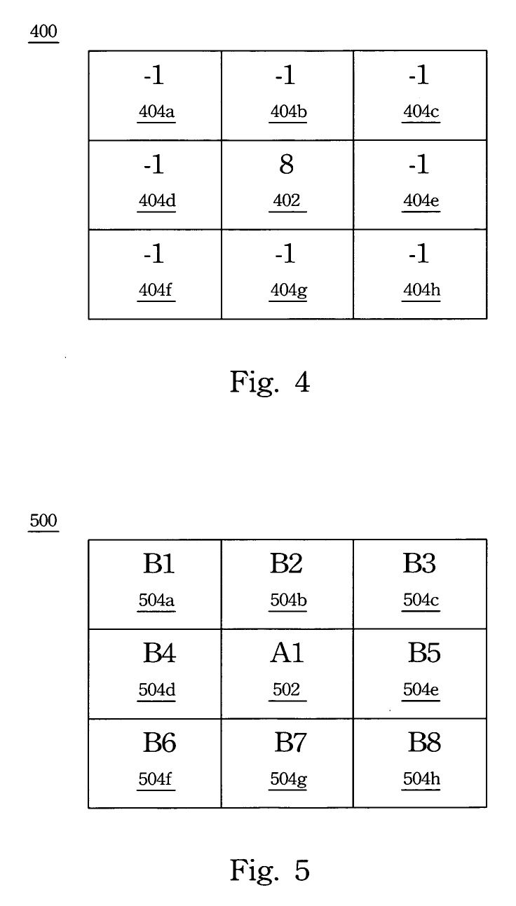

After an input pixel value 310 enters the system 300a, it first passes through the filtering module 302. The filtering module 302 outputs a filter value according to the result of filtering the input pixel value 310. The filter value is then used to determine whether the input pixel value 310 is within a high-frequency region of the image. The filtering process of the filtering module 302 can be achieved using the mask matrix 400 shown in FIG. 4.

To simplify the description, we use a 3×3 mask matrix 400 as an example, representing one embodiment of the filtering module 302. The matrix element 402 corresponds to the position of the mask input pixel value 310. The matrix elements 404a-404h around the matrix elements 402 correspond to the surrounding pixel values of the 8 pixels around the mask input pixel value 310. Please refer simultaneously to FIG. 5. The input pixel 310 is multiplied by a first weight value (e.g., the positive weight value 8 shown in 402 of FIG. 4) to generate a parameter A1 502. Likewise, the surrounding pixel values of the 8 pixels around the input pixel value 310 are multiplied by a second weight value (e.g., the negative weight value −1 shown in 404a-404h of the drawing) to generate the parameters B1-B8 504a-504h. Finally, the parameter A1 and the parameters B1-B8 are all added up to give a filter value generated by the filtering module 302 shown by FIG. 3A. It should be mentioned that if the input pixel value 310 is in the high-frequency region, then the difference between it and its surrounding pixel values is larger and the computed filter value is also larger. On the other hand, if the input pixel value 310 is in a low-frequency region, then the computed filter value is smaller or even 0.

With further reference to FIG. 3A, after the adjusting module 306 receives the filter value output by the filtering module 302, it first determines whether the compensation value is larger than a predetermined threshold value. In this embodiment, when the filter value is larger than the threshold value, the adjusting module 306 outputs the threshold value. When the compensation value is smaller than the threshold value, then the adjusting module 306 directly outputs the compensation value.

Finally, the merging module 308 merges the threshold value or compensation value output by the adjusting module 306 with the input pixel value 310 to generate an output pixel value 314. In one embodiment of the invention, the merging method is to combine the input pixel value 310 and the threshold value or the input pixel value 310 and the compensation value (according to the output of the adjusting module 306).

Moreover, in order for the filter value output by the filtering module 302 to be more easily processed, a gain module 304 is inserted between the filtering module 302 and the adjusting module 306 in another embodiment of the image sharpness processing system 300b, as shown in FIG. 3B. The filter value output by the filtering module 302 is multiplied by a gain value 312 in the gain module 304 to increase its strength. The gain value 312 controls the magnitude of the filter value and can be adjusted according to needs. The gain value 312 can be set to be 1 to leave the filter value invariant. Using the above-mentioned method and system to do experiments, the invention is found to effectively increase and flexibly control the sharpness of the image. In a preferred embodiment of the invention, the input pixel range is set between 0 and 1023 (in 10 bits). Setting the threshold value between 0 and 63 (in 6 bits) can achieve a good sharpness enhancement effect.

The invention being thus described, it will be obvious that the same may be varied in many ways. For example, the invention may be applied to a noise signal processing system. The only difference is to use a different filtering module. Such variations are not to be regarded as a departure from the spirit and scope of the invention, and all such modifications as would be obvious to one skilled in the art are intended to be included within the scope of the following claims.

What is claimed is:

1. An image processing method, comprising the steps of:
providing an input pixel value;
filtering the input pixel value to generate a filter value; and
determining whether the filter value is greater than a predetermined threshold value, the result of which is used to output an output pixel value;
wherein when the filter value is greater than the threshold value, the output pixel value is the input pixel value merged with the threshold value.

2. The image processing method of claim 1, wherein the output pixel value is the input pixel value merged with the filter value when the filter value is smaller than the threshold value.

3. The image processing method of claim 1, wherein the step of gaining the filter value is inserted between the filtering step and the determining step.

4. The image processing method of claim 3, wherein the filter value is obtained by multiplying the filter value by a gain value.

5. The image processing method of claim 1, wherein the filtering step includes the steps of:
multiplying the input pixel value by a first weight value to generate a first parameter;
multiplying a plurality of peripheral pixel values around the input pixel value by a second weight value and summing them up to generate a second parameter; and
adding up the first parameter and the second parameter to generate the filter value.

6. The image processing method of claim 1, wherein the input pixel value is between 0 and 1023.

7. The image processing method of claim 1, wherein the threshold value is between 0 and 63.

8. An image processing system, comprising:
a filtering module used to filter an input pixel value for generating a filter value;
an adjusting module used to determine whether the filter value is greater than a threshold value, thereby determining whether to output the threshold value or the filter value; and
a merging module;
wherein the merging module combines the input pixel value with the threshold value to generate an output pixel value when the adjusting module outputs the threshold value, and the merging module combines the input pixel value with the filter value to generate an output pixel value when the adjusting module outputs the filter value.

9. The image processing system of claim 8, wherein the adjusting module outputs the threshold value when the filter value is greater than the threshold value, otherwise, the adjusting module outputs the filter value.

10. The image processing system of claim 8 further comprising a gain module for enhancing the strength of the filter value.

11. The image processing system of claim 10, wherein the gain module enhances the filter value by multiplying the filter value with a gain value.

12. The image processing system of claim 8, wherein the input pixel value is between 0 and 1023.

13. The image processing system of claim 8, wherein the threshold value is between 0 and 63.
